(19) United States
(12) Patent Application Publication
(10) Pub. No.: US 2003/0108302 A1
(43) Pub. Date: Jun. 12, 2003

(54) Protective sleeve for fiber-optic plug connector

(76) Inventor: Ru-Chin Chang, Shu-Lin City (TW)

Correspondence Address: LAW OFFICE OF LIAUH & ASSOC., 4224 WAIALAE AVE, STE 5-388, HONOLULU, HI, 96816

(21) Appl. No.: 10/013,274

(22) Filed: Dec. 8, 2001

(51) Int. Cl. G02B 6/36

(52) U.S. Cl. 385/76

(57) ABSTRACT

A protective sleeve for a plug connector of an optical fiber includes an axial hole via which the plug connector is extended to firmly locate thereat, a flexible connecting element integrally formed on an outer wall of the protective sleeve to extend outward by a predetermined distance, and a dust cap integrally connected to an outer end of the flexible connecting element. The dust cap may be directed to cover an outer end of the plug connector located in the axial hole of the protective sleeve and thereby ensures good light signal transmission quality via the optical fiber.

### BACKGROUND OF THE INVENTION

The present invention relates to a protective sleeve for fiber-optic plug connector. The protective sleeve includes an integrally formed dust cap adapted to cover an outer end of the fiber-optic plug connector to ensure good signal transmission quality of an optical fiber.

An optical fiber is used as a signal transmission line and has the following features and advantages:

1. The optical fiber is mainly used to transmit light-wave signals and belongs to a signal line for wide-band transmission. It could be used to transmit a widened range of signals.

2. The optical fiber transmits light waves instead of electric waves. It does not generate induced electromagnetic waves and is therefore not interfered by and does not interfere with other radio communication apparatus in the course of signal transmission. That is, it provides stable and good transmission quality.

3. The optical fiber transmits signals at increased speed and is recognized by the communication industry as the best type of transmission line.

However, the optical fiber is expensive and is generally used as audio signal transmission line in most home stereos or as the signal transmission line for personal data assistants (PDA), digital versatile disks (DVD), etc., to obtain good sound and picture quality.

The transmission quality of the optical fiber tends to be seriously affected when the optical fiber is covered by dust. It is therefore necessary to cover front ends of plug connectors provided at two ends of the optical fiber with dust caps. Please refer to FIG. 3. An optical fiber 10 has two plug connectors 11 provided at two ends thereof. A protective sleeve 12 is fixedly mounted on each of the two plug connectors 11 to protect the same. FIG. 1 shows a conventional dust-protecting means 13 for the optical fiber 10. The dust-protecting means 13 includes a ring member 14, a connecting member 15, and two dust caps 16 serially and closely connected to an outer end of the connecting member 15. The ring member 14 is put around a rear end of one of the two protective sleeves 12 to connect the two dust caps 16 to the protective sleeves 12, as shown in FIG. 2. The optical fiber 10 is supplied with the two dust caps 16 mounted on outer ends of the plug connectors 11 at two ends of the optical fiber 10, as shown in FIG. 3. Since the two dust caps 16 are closely and serially connected to the connecting member 15, the optical fiber 10 with the dust-protecting means 13 mounted thereon would have two closely arranged plug connectors 11. When a user wants to use the optical fiber 10, the two plug connectors thereof are closely bound together by the two closely and serially connected dust caps 16, making the optical fiber 10 in a bent condition that prevents the user from conveniently trying different ways of wiring the optical fiber 10.

Moreover, assembling of the dust-protecting means 13 to the protective sleeve 12 requires additional labor and time to increase the manufacturing cost of the optical fiber 10 and reduce its competition ability in the markets.

### SUMMARY OF THE INVENTION

A primary object of the present invention is to provide a protective sleeve that protects a fiber-optic plug connector and includes an integral dust cap for conveniently covering an outer end of the fiber-optic plug connector.

To achieve the above and other objects, the protective sleeve for fiber-optic plug connector according to the present invention includes an axial hole through which the plug connector of the optical fiber is extended to firmly locate thereat, an integrally formed flexible connecting member extended from an outer wall of the protective sleeve by a predetermined distance, and a dust cap integrally connected to an outer end of the flexible connecting element for covering an outer end of the plug connector.

The dust cap integrally formed with the protective sleeve also enables reduced manufacturing cost of the optical fiber.

### BRIEF DESCRIPTION OF THE DRAWINGS

The structure and the technical means adopted by the present invention to achieve the above and other objects can be best understood by referring to the following detailed description of the preferred embodiments and the accompanying drawings,

FIG. 1 is an exploded perspective view of a conventional protective sleeve for fiber-optic plug connector and a dust-protecting means;

FIG. 2 is an assembled perspective view of FIG. 1;

FIG. 3 illustrates an optical fiber having the conventional protective sleeve and dust-protecting means of FIG. 1 mounted on two plug connectors thereof;

FIG. 4 is a perspective view of a protective sleeve for fiber-optic plug connector according to the present invention; and

FIG. 5 illustrates an optical fiber having the protective sleeve of FIG. 4 mounted on two plug connectors thereof.

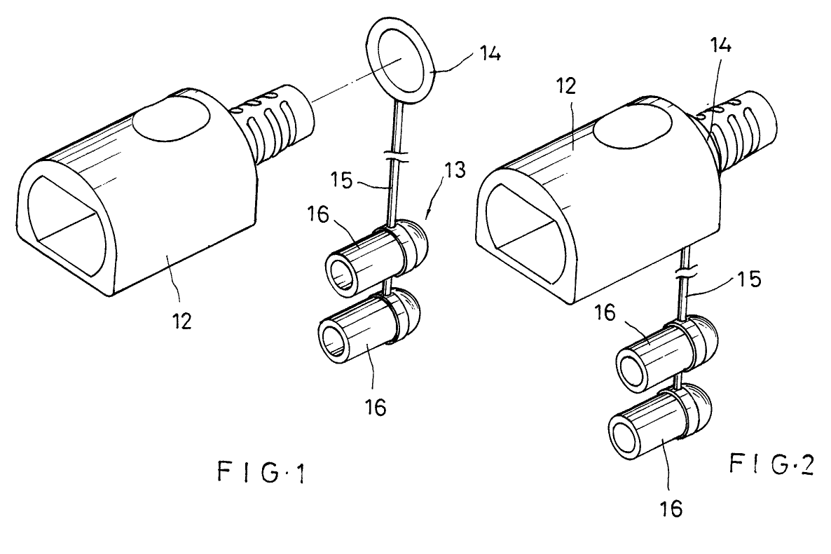

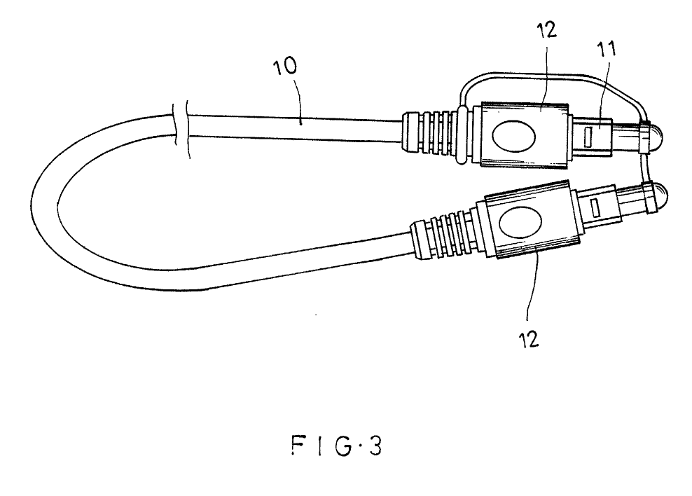

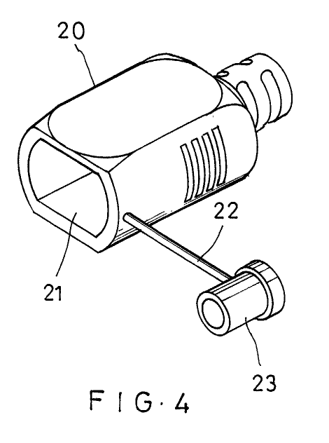

### DETAILED DESCRIPTION OF THE PREFERRED EMBODIMENTS

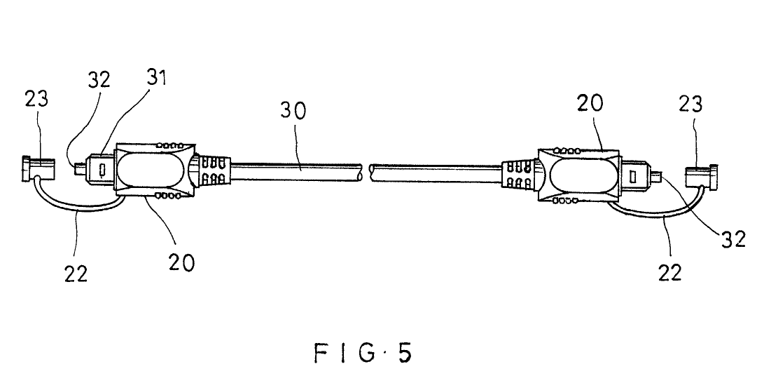

Please refer to FIG. 4 that is a perspective view of a protective sleeve 20 for fiber-optic plug connector according to a preferred embodiment of the present invention, and to FIG. 5 that shows an optical fiber 30 being provided at two ends with two plug connectors 31.

The protective sleeve 20 includes an axial hole 21 through which the plug connector 31 of the optical fiber 30 is extended to firmly locate thereat. The protective sleeve 20 is integrally formed on an outer wall with a flexible connecting element 22 outward extended by a predetermined length. A dust cap 23 is integrally connected to an outer end of the flexible connecting element 22 for covering an outer end 32 of the plug connector 31.

The dust cap 23 is an integral part of the protective sleeve 20 to maintain an excellent connection to the protective sleeve 20 via the flexible connecting element 22. When the dust cap 23 is directed to cover the outer end 32 of the plug connector 31 of the optical fiber 30, the plug connector 31 is well protected against dust.

Each protective sleeve 20 of the present invention includes only one dust cap 23 for covering the outer end 32 of one plug connector 31 provided at one end of the optical fiber 30. Therefore, the optical fiber 30 with two protective sleeves 20 separately mounted on two plug connectors 31 thereof may still be pulled straight, advantageously allowing a user to try different ways of wiring the optical fiber 30.

Since the dust cap 23 is integrally formed with the protective sleeve 20, the risk of a separated dust cap 23 from the protective sleeve 20 is eliminated, and assembling of the dust cap 23 to the protective sleeve 20 is saved to reduce the manufacturing cost of the optical fiber 10.

In brief, the protective sleeve for fiber-optic plug connector provided by the present invention includes integrally formed dust cap to ensure excellent connection of the dust cap to the protective sleeve and enables the user to use the optical fiber in a more convenient manner.

What is claimed is:

1. A protective sleeve for a plug connector of an optical fiber, comprising an axial hole for said plug connector of said optical fiber to extend therethrough and firmly locate thereat, a flexible connecting element integrally formed on an outer wall of said protective sleeve to extend outward by a predetermined distance, and a dust cap integrally connected to an outer end of said flexible connecting element and adapted to mount onto an outer end of said plug connector forward projected from said axial hole of said protective sleeve.
